(19) United States
(12) Patent Application Publication
(10) Pub. No.: US 2025/0207656 A1
(43) Pub. Date: Jun. 26, 2025

(54) PENDULAR ROCKER DAMPER WITH OVERLOAD PROTECTION, AND HYBRID POWERTRAIN

(71) Applicant: Schaeffler Technologies AG & Co. KG, Herzogenaurach (DE)

(72) Inventors: Martin Loth, Bühl (DE); Eduard Wagner, Offenburg (DE); Balamurugan Manoharan, Bühl (DE)

(73) Assignee: Schaeffler Technologies AG & Co. KG, Herzogenaurach (JP)

(21) Appl. No.: 18/020,643

(22) PCT Filed: Jul. 5, 2021
(86) PCT No.: PCT/DE2021/100575

§ 371 Date: Jul. 21, 2023

(30) Foreign Application Priority Data
Aug. 14, 2020 (DE) 10 2020 121 387.5
Oct. 19, 2020 (DE) 10 2020 127 456.4

(51) Int. Cl. F16F 15/12; F16F 15/134

(52) U.S. Cl. CPC F16F 15/1205; F16F 15/134

(57) ABSTRACT

A pendular rocker damper for a hybrid powertrain of a motor vehicle includes a primary component, a stop attached to the primary component, a secondary component rotatable relative to the primary component, a counter stop attached to the secondary component, a rocker element used for torque transmission, first and second roller bodies arranged to roll in respective guide tracks, and a compression spring. The rocker element is suspended on the primary component and the secondary component in a pendular manner. The first roller body couples the rocker element to the primary component and the second roller body couples the rocker element to the secondary component. The compression spring resiliently supports the rocker element. The stop interacts with the counter stop to support the primary component relative to the secondary component in a circumferential direction once the compression spring is displaced by a specified elastic spring deflection.

### CROSS-REFERENCE TO RELATED APPLICATIONS

This application is the United States National Phase of PCT Appln. No. PCT/DE2021/100575 filed Jul. 5, 2021, which claims priority to German Application Nos. DE102020121387.5 filed Aug. 14, 2020 and DE102020127456.4 filed Oct. 19, 2020, the entire disclosures of which are incorporated by reference herein.

### TECHNICAL FIELD

The present disclosure relates to a pendular rocker damper for a hybrid powertrain of a motor vehicle, such as a passenger car, truck, bus or other commercial vehicle, having a primary component, a secondary component that can be rotated relative to the primary component to a limited degree, and at least one rocker element which is suspended on the primary component and the secondary component in a pendular manner and which is used for torque transmission. The at least one rocker element is coupled to the primary component by means of a first roller body that is received/mounted so as to roll in guide tracks (in that the first roller body is mounted/received so as to roll in guide tracks of the primary component and of the at least one rocker element) and/or is coupled to the secondary component by means of a second roller body likewise received/mounted in guide tracks so as to roll (in that the second roller body is mounted/received so as to roll in guide tracks of the secondary component and of the at least one rocker element). The at least one rocker element is resiliently supported by at least one compression spring. In addition, the present disclosure relates to a hybrid powertrain for a (hybrid) motor vehicle with said pendular rocker damper.

According to the present disclosure, a pendular rocker damper is to be understood as meaning a vibration damping apparatus which has a plurality of rocker elements which are received in a pendular manner and which have movements during operation that have a damping effect on the torsional vibrations occurring in the powertrain. At least the rocker elements of this pendular rocker damper are used (in a torque-transmitting manner) in the torque flow between the primary component and the secondary component.

### BACKGROUND

Pendular rocker dampers of the type in question are already sufficiently known in the prior art. For example, WO 2018/215018 A1 discloses a torsional vibration damper with a torque limiter, which is preferably used in a clutch disk of a clutch. Further prior art is also known in this context from DE 10 2018 108 441 A1 and DE 10 2015 211 899 A1.

It has also been shown that different situations during operation of a powertrain mean that significantly more torque has to be transmitted via the pendular rocker damper than during nominal operation. Examples of this are misfiring of an individual cylinder in the internal combustion engine or a jump in the coefficient of friction during braking of the motor vehicle. Depending on the speed and the torque transmitted, a misfire can result in an impact torque that is 20 times higher than the actual engine torque. However, an impact torque can also occur during overrun operation, for example when the friction partner for the tire of the motor vehicle changes during braking. This occurs, for example, at the transition from icy asphalt to non-icy asphalt. Especially in the case of powertrains in which the combustion engine and electric motor are fixedly coupled and cannot be separated from one another, the entire impact torque can be routed through the pendular rocker damper.

### SUMMARY

The present disclosure provides a pendular rocker damper which is designed to receive and transmit high torque peaks occurring during operation without damage.

According to the disclosure, this is achieved in that a stop attached to the primary component interacts with a counter stop attached to the secondary component such that the primary component and the secondary component are supported in relation to one another (e.g., directly against each other) in a circumferential direction/rotational direction after the at least one compression spring is displaced by a specified elastic spring deflection (and before reaching a complete elastic compression, for example).

As a result, the pendular rocker damper is equipped with robust impact protection/overload protection, which is integrated into the pendular rocker damper in an installation space-saving manner.

The stop may be formed by a tab projecting radially inwards. As a result, the stop is designed to save installation space. That tab may be formed by stamping and/or bending on a (single- or multi-part) mass ring formed from a metal sheet (steel sheet). As a result, the stop can also be produced efficiently.

Furthermore, the counter stop may be formed on a flange plate of the secondary component. As a result, the counter stop can also be designed to save installation space. That flange plate may be riveted to an output flange of the secondary component. With this, the flange plate is also easy to mount.

If the (substantially plate-like and/or radially running) flange plate is arranged in such a way that the counter stop is positioned adjacent to the stop in the circumferential direction, but at the same level in the radial direction and in the axial direction as the stop, a short axial design is achieved.

The stop may be formed on a (single- or multi-part) mass ring which at least partially also forms the primary component. As a result, the stop can be integrated into existing elements of the primary component in a skillful manner.

In this regard, the mass ring may have a completely circumferential/continuous ring region (or alternatively consisting of a plurality of sub-segments adjoining one another in the circumferential direction), and the tab forming the stop may be integrally formed with said ring region (/with a sub-segment). This further simplifies the structure.

A weak point (e.g., in the form of a recess/through-hole) which reduces the rigidity (torsional rigidity) in a targeted manner in relation to the ring region may be introduced in a transition region between the stop and the ring region. This further improves the capacity of the overload protection.

The stop may be arranged on a continuously circumferential stop ring region (or alternatively consisting of a plurality of sub-segments adjoining one another in the circumferential direction) and this stop ring region may be coupled by means of a perforated transition region to a ring region further connected to at least one ring element of the primary component.

If a plurality of stops and a plurality of counter stops, each associated with a stop, are arranged in a distributed manner in the circumferential direction, the overload protection is designed to be robust. Therefore, a plurality of tabs comprising the stop may be arranged alternately in the circumferential direction with a plurality of spring plates comprising the counter stop.

The primary component may have a ring element (designed continuous/in one piece in the circumferential direction or consisting of a plurality of sub-segments adjoining one another in the circumferential direction), which ring element with its radial inner side directly forms a plurality of (first) guide tracks that are in (rolling) contact with the first roller bodies. This further simplifies the structure of the pendular rocker damper.

In this regard, at least one of the first roller bodies may be in (rolling) contact with a (second) guide track of the rocker element, received in a pendular manner, of the pendular rocker damper.

Furthermore, the ring element may be fastened to an input flange of the primary component which is screwed to the crankshaft. This further simplifies the installation of the pendular rocker damper.

The secondary component may have an output flange, which output flange forms a plurality of (fourth) guide tracks which are in (rolling) contact with second roller bodies. This also further simplifies the structure of the pendular rocker damper, which, at the same time, is also designed to be robust.

Furthermore, at least one of the second roller bodies may be in (rolling) contact with a (third) guide track of the rocker element, received in a pendular manner, of the pendular rocker damper. The rocker elements thus may have at least one (second) guide track, which is in contact with the at least one first roller body, and a further (third) guide track, which is in contact with the at least one second roller body. This keeps the structure compact.

In an alternative embodiment, two intermediate stops may be provided on the rocker element, of which a first intermediate stop (of the rocker element) interacts with the stop of the primary component/can be brought directly into contact with it, and a second intermediate stop (of the rocker element) interacts with the counter stop of the secondary component/can be brought directly into contact with it. This simplifies the structure of the pendular rocker damper, reduces the number of components present and further shortens the axial design of the pendular rocker damper. Therefore, the primary component and the secondary component are alternatively supported indirectly relative to one another. The second intermediate stop of the rocker element may be arranged radially inside the first intermediate stop.

Furthermore, the present disclosure relates to a hybrid powertrain for a motor vehicle, having an internal combustion engine and a pendular rocker damper according to one of the previous embodiments. with the primary component of the pendular rocker damper attached to a crankshaft of the internal combustion engine. The hybrid powertrain also has an electric drive machine and a separating clutch operatively inserted between the internal combustion engine and the electric drive machine.

The pendular rocker damper is operatively inserted in a particularly effective manner when the separating clutch is arranged between the secondary component of the pendular rocker damper and the electric drive machine.

Furthermore, the present disclosure relates to a motor vehicle having a hybrid powertrain according to at least one of the embodiments described above. The crankshaft is oriented transverse, e.g., perpendicular, or parallel to a vehicle longitudinal axis.

In other words, according to the present disclosure, a pendular rocker damper is therefore provided with an impact protection. The pendular rocker damper, for example, as a replacement for a dual-mass flywheel, is therefore provided with protection against extraordinary torque peaks/impacts in order to protect the compression springs from this high torque. For this purpose, the pendular rocker damper has a mass ring with stops and stop flanges (flange plates) as counterparts. The mass ring is part of the primary mass (primary component) and provides the stop flanges with a stop in the event of an impact before the compression springs move to block. The stop flanges are mounted on the secondary mass (secondary component) and are thus movable relative to the primary mass in the circumferential direction. In an example pendular rocker damper, the rocker plates/pendular rockers/rocker elements are located in the torque flow, and energy stores (having a plurality of compression springs) that prestress the pendular rockers against one another are located outside the torque flow. In principle, however, it is also possible, according to further embodiments, for the respective energy store to be located in the torque flow.

### BRIEF DESCRIPTION OF THE DRAWINGS

The present disclosure is now be explained in more detail with reference to drawings, in which context various exemplary embodiments are also shown.

In the drawings:

FIG. 1 shows a front view of a pendular rocker damper according to a first exemplary embodiment, as can be used in a hybrid powertrain, wherein the pendular rocker damper is illustrated in the left-hand half of the illustration with flange plates acting as counter stops and in the right-hand half of the illustration without these flange plates, and existing rocker elements are clearly visible by their support on a spring unit;

FIG. 2 shows a front view of the pendular rocker damper according to FIG. 1, wherein an output flange and the flange plates attached thereto are hidden in order to reveal a friction device which is operatively inserted between a primary component and a secondary component;

FIG. 3 shows a perspective view of a mass ring associated with the primary component of the pendular rocker damper;

FIG. 4 shows a front view of the mass ring according to FIG. 3;

FIG. 5 shows a longitudinal sectional view of the mass ring according to FIGS. 3 and 4;

FIG. 6 shows a longitudinal sectional view of the pendular rocker damper according to FIG. 1;

FIG. 7 shows an exploded view of the pendular rocker damper from FIG. 1;

FIG. 8 shows a longitudinal sectional view of the pendular rocker damper according to FIG. 1, wherein the sectional plane is chosen such that a first roller body which couples the primary component to one of the rocker elements is also sectioned;

FIG. 9 shows a sectional view of a rocker element used in the pendular rocker damper, whereby a rivet element connecting two spaced rocker plates can be seen in more detail;

FIG. 10 shows a perspective view of the rivet element used in FIG. 9;

FIG. 11 shows a perspective view of the sectioned rocker element according to FIG. 9;

FIG. 12 shows a perspective view of a support disk associated with the friction device;

FIG. 13 shows a front view of a pendular rocker damper according to a second exemplary embodiment, which differs from the first exemplary embodiment in the design of the mass ring;

FIG. 14 shows a perspective view of the mass ring used in FIG. 13;

FIG. 15 shows a front view of the mass ring according to FIG. 14;

FIG. 16 shows an exploded view of the pendular rocker damper according to FIG. 13;

FIG. 17 shows a longitudinal sectional view of the pendular rocker damper of the first exemplary embodiment, similar to FIG. 8, in which the primary component is connected for conjoint rotation with a schematically shown crankshaft of an internal combustion engine; and

FIG. 18 shows a front view of a hybrid powertrain according to the present disclosure including the pendular rocker damper according to one of FIGS. 1 to 16.

### DETAILED DESCRIPTION

The drawings are merely schematic in nature and are therefore intended solely for the purpose of understanding the disclosure. The same elements are provided with the same reference signs.

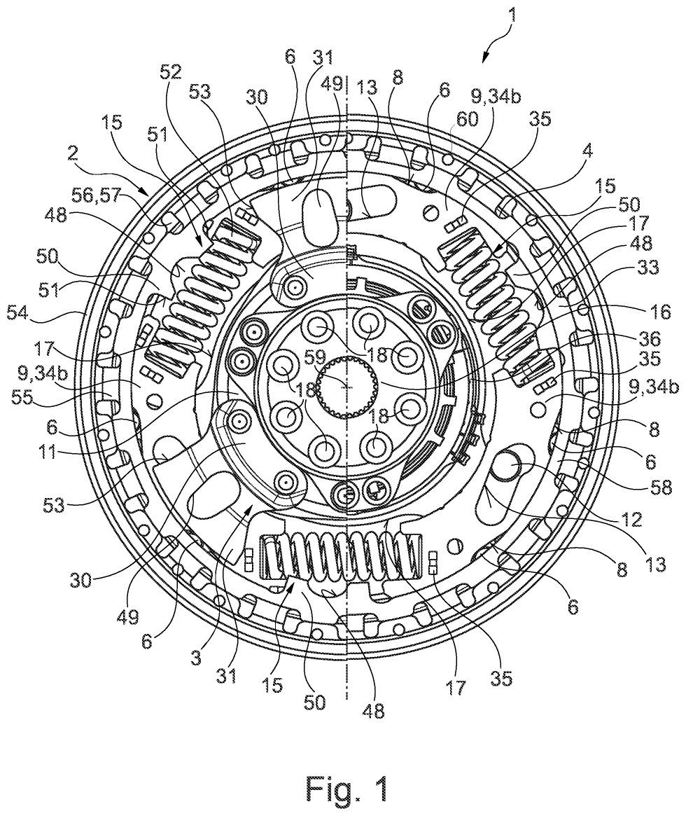

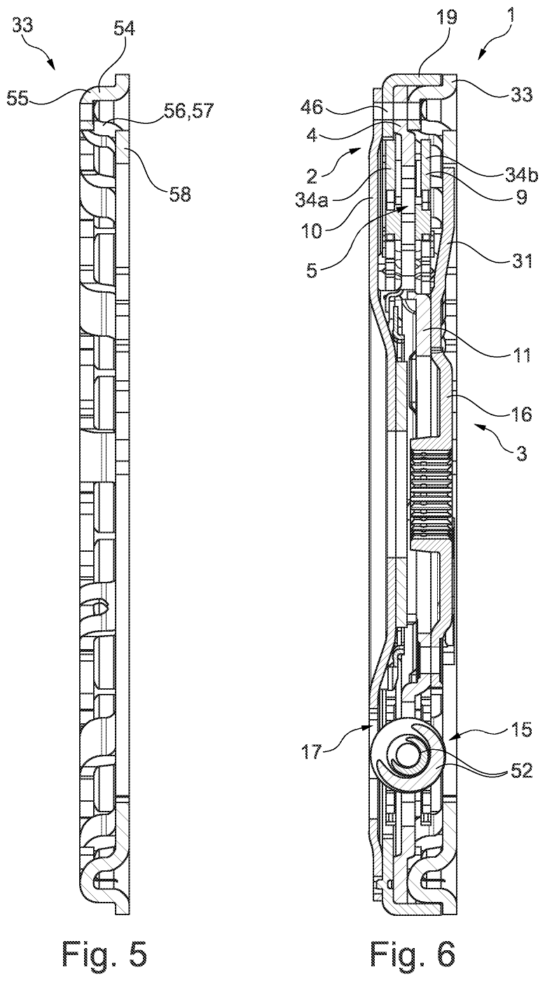

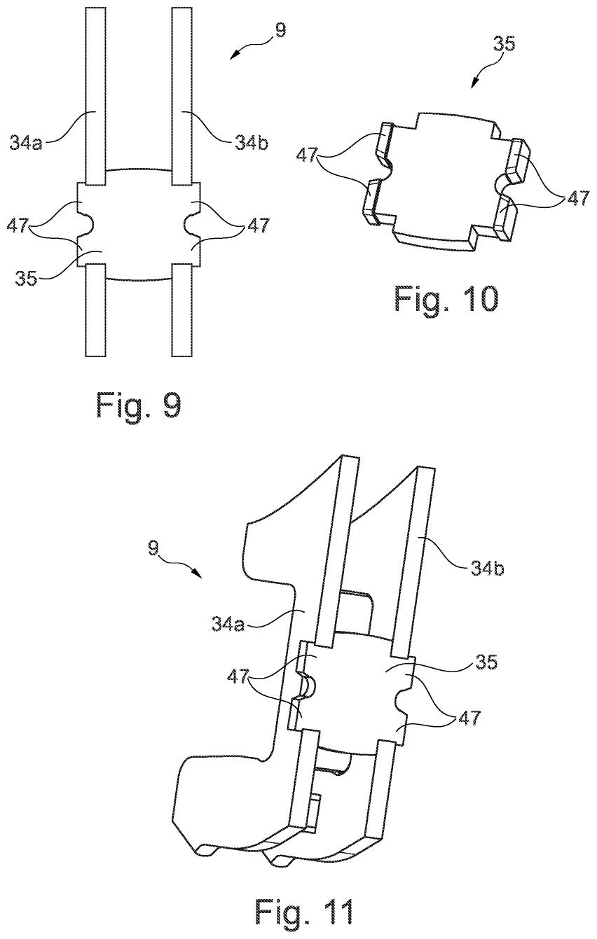

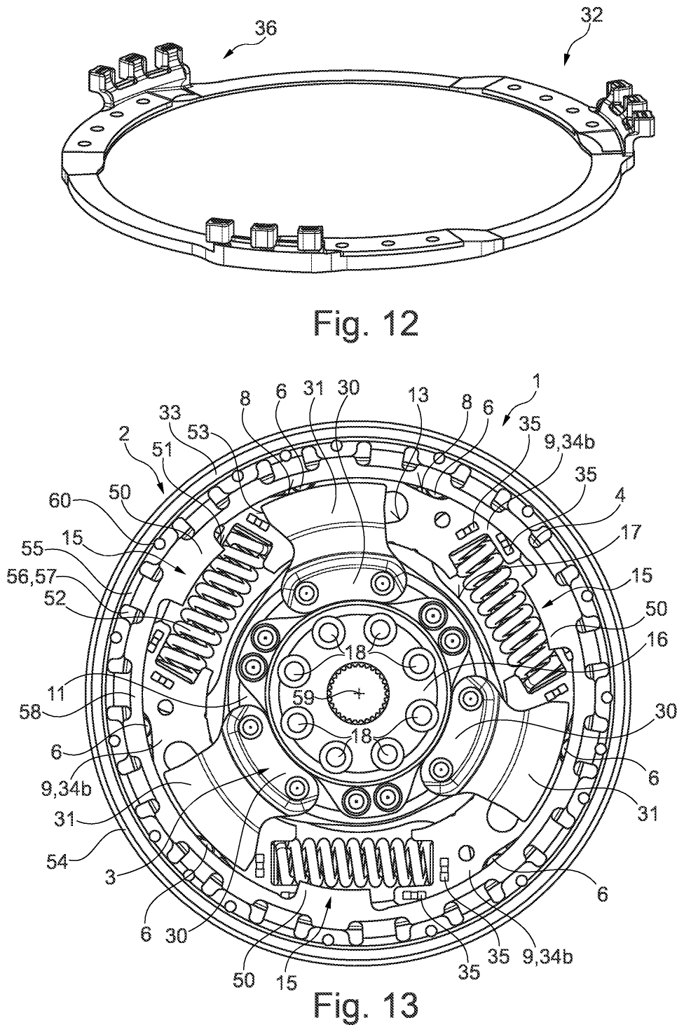

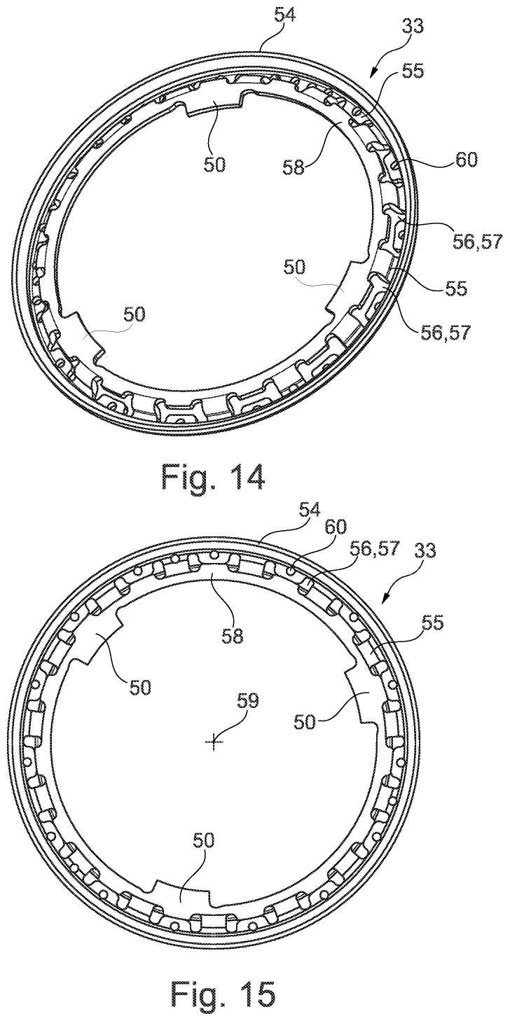

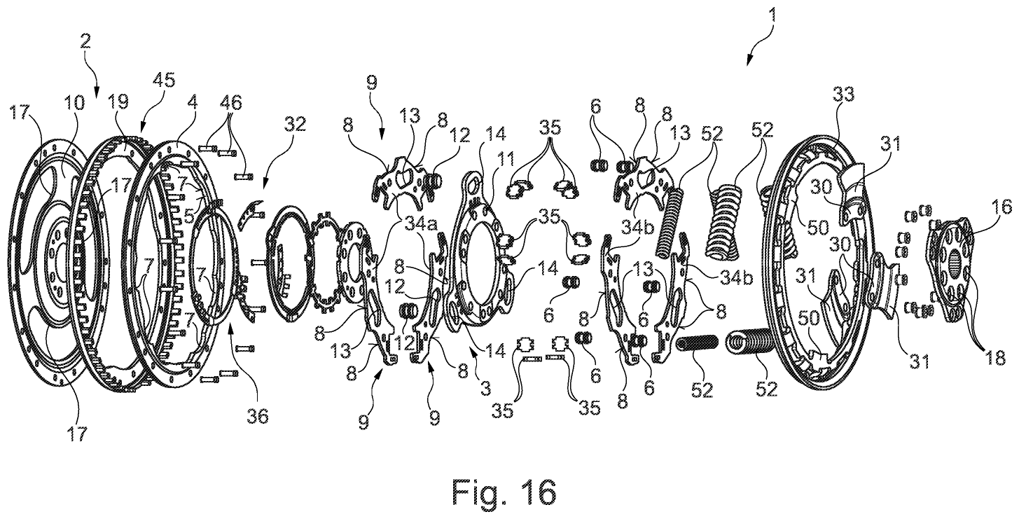

FIG. 18 shows a basic structure of a hybrid powertrain 20 according to the present disclosure. This hybrid powertrain 20 includes a pendular rocker damper 1 according to one of the two exemplary embodiments illustrated in FIGS. 1 to 16. The hybrid powertrain 20 is used in a partially illustrated motor vehicle 21 in FIG. 18. The hybrid powertrain 20 is used to drive a plurality of wheels 37 of the motor vehicle 21, which can be seen in the Figure.

The hybrid powertrain 20 also has an internal combustion engine 22, e.g., in the form of a gasoline engine or diesel engine, which can be coupled to a transmission 38 via clutches 25, 28a and 28b. The transmission 38 may be implemented as an automatic transmission. On the part of the two transmission input shafts 39a, 39b, the transmission 38 has two clutches 28a, 28b forming a dual clutch device. Either the first transmission input shaft 39a (via the first clutch 28a) or the second transmission input shaft 39b (via the second clutch 28b) can be coupled to a central carrier 27 by means of these two clutches 28a, 28b (forming sub-clutches of the dual clutch device).

The carrier 27 is permanently rotationally connected to a rotor 26 of an electric drive machine 24. In this embodiment, the electric drive machine 24 is arranged axially parallel to the carrier 27, and the carrier 27 is in turn arranged coaxially with respect to a crankshaft 23 of the internal combustion engine 22. The crankshaft 23 is shown in simplified form as the axis of rotation. In this embodiment, the rotor 26 is mounted on a rotor shaft 40 and the rotor shaft 40 is permanently rotationally coupled to the carrier 27 via a gear stage 41 (spur gear stage).

The carrier 27 is further connected to an output-side (second) clutch component 42b of the separating clutch 25. An input-side (first) clutch component 42a of the separating clutch 25 is in turn coupled to the pendular rocker damper 1. The pendular rocker damper 1 is thus operatively inserted between the crankshaft 23 and the separating clutch 25/the first clutch component 42a of the separating clutch 25.

In this regard, it should be noted that the separating clutch 25 may be designed as a friction clutch. The first and the second clutch 28a. 28b may be designed as friction clutches, e.g., friction plate clutches.

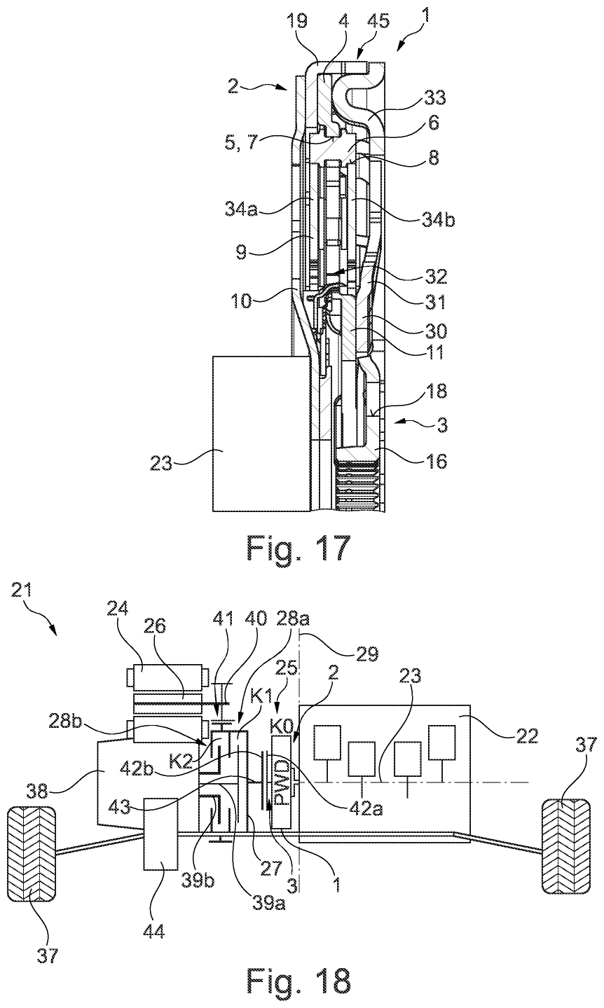

As can also be seen, for example, in connection with FIG. 17 for the pendular rocker damper 1 of the first exemplary embodiment, a primary component 2 of the pendular rocker damper 1 is screwed directly to the crankshaft 23. The screws for fixing the primary component 2 to the crankshaft 23 are not shown for the sake of clarity.

A secondary component 3 of the pendular rocker damper 1, which is received in a vibration-damped manner in relation to the primary component 2, is permanently connected to the first clutch component 42a. The secondary component 3 may be connected to this first clutch component 42a via an intermediate shaft 43.

As can also be seen from FIG. 18, the transmission 38 of the hybrid powertrain 20) is connected on the output side via a differential stage 44 to the wheels 37 of the motor vehicle 21 in order to drive the wheels 37 in the drive state/operating state of the hybrid powertrain 20.

FIGS. 1 to 16 illustrate the two exemplary embodiments of the pendular rocker damper 1 used in FIG. 18. A first exemplary embodiment of the pendular rocker damper 1 is shown in FIGS. 1 to 12; a second exemplary embodiment of the pendular rocker damper 1 is shown by FIGS. 13 to 16. However, the two exemplary embodiments are substantially identical in terms of their structure, which is why, for the sake of brevity, only the differences between these two exemplary embodiments are described below.

It should be noted that the directional indications used in the present case—axial, radial and circumferential direction—relate to a central axis of rotation 59 of the pendular rocker damper 1, which is oriented coaxially with respect to the crankshaft 23 during operation. Consequently, axially/axial direction is to be understood as a direction along/parallel to the axis of rotation 59; radially/a radial direction is to be understood as a direction perpendicular to the axis of rotation 59; and a circumferential direction is to be understood as a direction along an imaginary circular line that runs concentrically around the axis of rotation 59.

As can be seen initially for the first exemplary embodiment in FIGS. 6 to 8, the primary component 2 of the pendular rocker damper 1 is designed in several parts. The primary component 2 has a disk-like input flange 10 which is screwed directly to the crankshaft 23 during operation. The input flange 10 is provided with a plurality of (here three) recesses 17 arranged in a distributed manner in a circumferential direction and extending in an arcuate manner. A spring unit 15, which is described in more detail below, protrudes (axially) into these recesses 17.

Furthermore, a ring element 4 is connected for conjoint rotation with the input flange 10. This ring element 4 in turn interacts with a plurality of rocker elements 9 arranged in a distributed manner in the circumferential direction, as explained in more detail below.

The primary component 2 also has a transmission ring 19, which has a toothing 45. That toothing 45 is designed in such a way that it is used by a corresponding sensor to detect the rotational speed, or even to detect the rotary angular position of the primary component 2.

In this regard, it should be noted that the toothing 45 does not necessarily have to be present and also does not necessarily have to be designed as part of the transmission ring 19. In further embodiments, the transmission ring 19 can therefore also be omitted or designed as part of the mass ring 33 or as a further separate part, e.g. made of thinner material than the ring element 4 and/or the mass ring 33. In other embodiments, there is also a starter ring gear instead of the transmission ring 19/instead of the toothing 45, either with or without a transmitter toothing or transmitter contour.

In addition, the primary component 2 has a mass ring 33, described in more detail below; which forms a stop 51 for the secondary component 3 in terms of overload protection for the spring units 15. The components—input flange 10, ring element 4, transmission ring 19 and mass ring 33—of the primary component 2 are connected to one another via a plurality of rivet bolts 46 (FIG. 6). In further embodiments, these components of the primary component 2 are alternatively all or at least partially welded or adhesively bonded to one another instead of being riveted (by the rivet bolts 46).

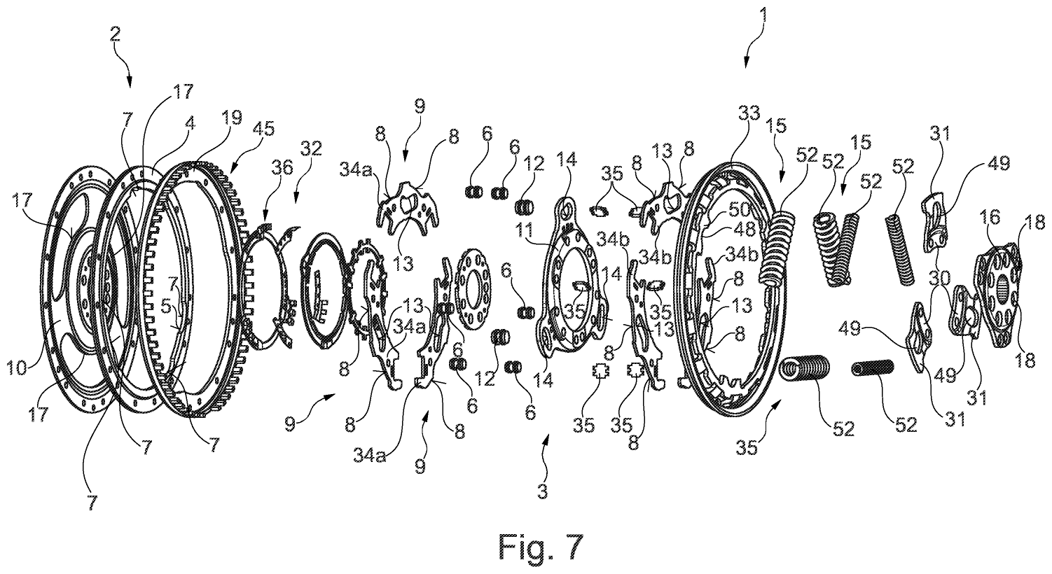

The primary component 2 is coupled to the secondary component 3 via a plurality of rocker elements 9 arranged in a distributed manner in the circumferential direction and can be rotated relative to the secondary component in a limited rotational angle range. The rocker elements 9) are each of the same design. As shown in FIGS. 7 and 9 to 11, each of the three rocker elements 9 arranged in a uniformly distributed manner in the circumferential direction has two axially spaced rocker plates 34a, 34b. These two rocker plates 34a, 34b may be designed as identical parts. Each pair of rocker plates 34a, 34b are connected to one another via two rivet elements 35. According to FIG. 10, the rivet elements 35 are designed as formable sheet metal segments. Rivet projections 47 of these rivet elements 35 penetrate the respective rocker plate 34a. 34b axially and are formed from a rear side for the interlocking and frictional fixing of the two rocker plates 34a. 34b to one another.

In further embodiments, the rivet elements 35 are alternatively designed as round bolts or even as a conventional rivet/rivet bolt. This may be advantageous if the rocker plates 34a, 34b are formed in such a way that the rocker plates 34a and 34b are spaced apart from one another in the region of the third guide tracks 13 such that the regions of the output flange 11 carrying the fourth guide tracks 14 can still be rotated to a limited extent between them.

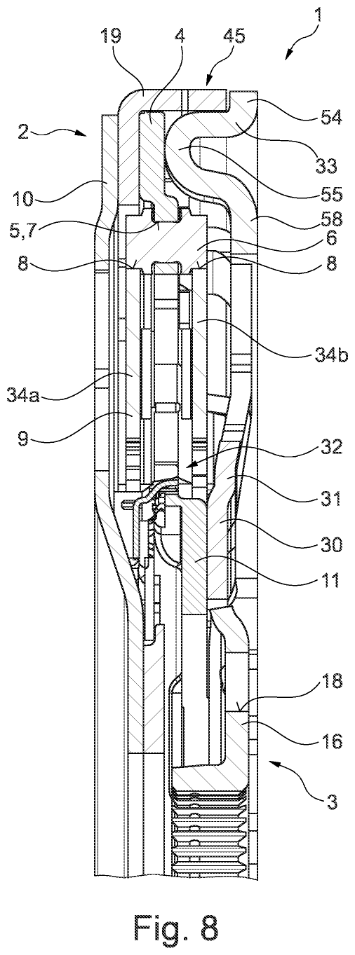

FIG. 8 also shows that the ring element 4 is coupled to the rocker elements 9 via a plurality of first roller bodies 6 arranged in a distributed manner in the circumferential direction. The ring element 4 has a plurality of first guide tracks 7 distributed in the circumferential direction, each of which receives a first roller body 6 in a rolling manner. The first guide tracks 7 are introduced on a radial inner side 5 of the ring element 4.

In this context, it should also be noted that the ring element 4 is segmented in a further embodiment, for example for better material utilization, and is therefore not designed to be completely circumferential/in one piece as here, but is made up of a plurality of sub-segments arranged next to one another in the circumferential direction. The sub-segments in the form of inserts carrying the roller track (i.e. each carrying the first guide track 7) may be fastened to the primary component 2/the ring element 4.

Each first roller body 6 is also in rolling contact with a second guide track 8 mounted directly on a radial outer side of the rocker plates 34a, 34b. Two second guide tracks 8 are provided for each rocker plate 34a, 34b, wherein two axially congruently arranged second guide tracks 8 in each case receive the same first roller body 6. There are two first roller bodies 6 for each rocker element 9. There is thus a total of six first roller bodies 6.

Each rocker element 9) is also in rolling contact with a further second roller body 12. The second roller body 12 is arranged radially inside the first roller bodies 6. The second roller body 12 is in rolling contact with a third guide track 13 of the rocker plate 34a, 34b. In addition, the second roller body 12 is in rolling contact with a fourth guide track 14, which in turn is formed on an output flange 11 of the secondary component 3.

As a result, the two components—primary component 2 and secondary component 3—are rotationally coupled to one another via the rocker elements 9 and the corresponding roller bodies 6, 12, wherein these two components 2, 3 are arranged in different relative rotational positions according to the position of the rocker elements 9. While the first roller bodies 6 rotationally couple the primary component 2 to the rocker elements 9), the second roller bodies 12 are used to couple the rocker elements 9 to the secondary component 3.

Furthermore, energy stores in the form of (mechanical) spring units 15 are used in the circumferential direction between the mutually spaced rocker elements 9. Each spring unit 15 has at least one compression spring 52, here even two compression springs 52 in the form of helical compression springs. The two compression springs 52 are operatively inserted in parallel and nested/arranged coaxially with one another.

Each of the three spring units 15 consequently supports the two rocker elements 9, arranged next to one another in the circumferential direction, in a resilient manner relative to one another (in their pendulum movement) in the circumferential direction.

In this regard, it should be noted that the spring units 15 used are therefore not arranged along a torque transmission path from the primary component 2 to the secondary component 3. In further embodiments, however, it is also possible to arrange said spring unit 15 in the torque flow and consequently to support the primary component 2 and/or the secondary component 3 via the spring units 15 on the rocker element 9 for torque transmission.

It should also be noted that in further embodiments, more than one spring unit 15 is used as an energy store between two rocker elements 9, which are then optionally radially or axially offset, depending on the nature of the available installation space.

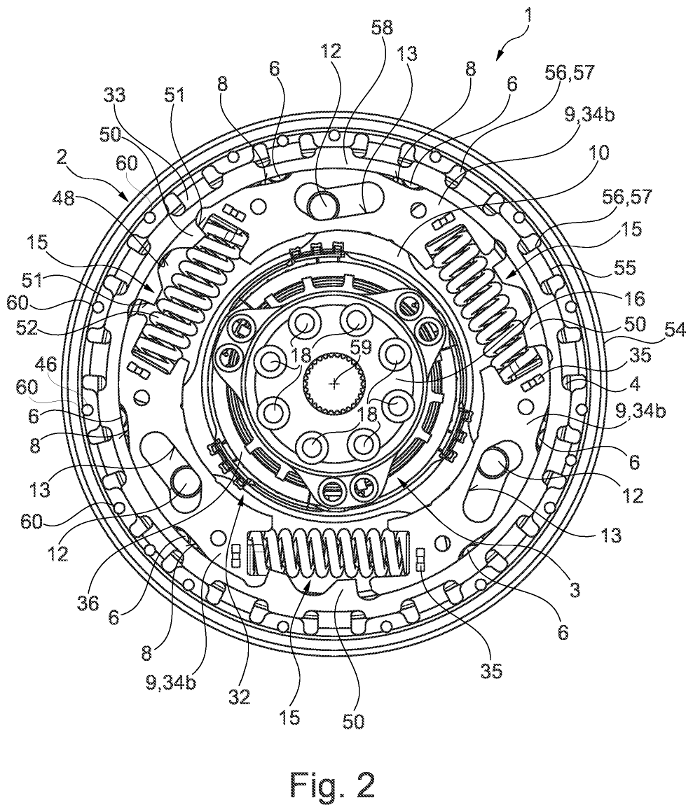

Furthermore, a friction device 32 can be seen in FIGS. 2, 7 and 12, which is also configured in the pendular rocker damper 1. This friction device 32 has, among other things, a support disk 36 and acts between the primary component 2 and the secondary component 3 in such a way that it dampens a relative movement between the primary component 2 and the secondary component 3.

It can also be seen in FIG. 7 that the secondary component 3 has, in addition to the output flange 11, a hub element 16 which is firmly connected to it. The hub element 16 is that part of the secondary component 3 which is directly connected to the intermediate shaft 43 leading to the separating clutch 25 in the hybrid powertrain 20 according to FIG. 18.

The secondary component 3 also has a plurality of flange plates 31 arranged in a distributed manner in the circumferential direction, which extend in the radial direction in the form of plates. The flange plates 31 are attached, namely riveted, to the output flange 11. Each flange plate 31 forms a counter stop 53 which interacts with the stop 51. Thus, the overload protection according to the invention for the spring units 15/compression springs 52 is provided by interaction of the mass ring 33 with the flange plates 31, as described in more detail below.

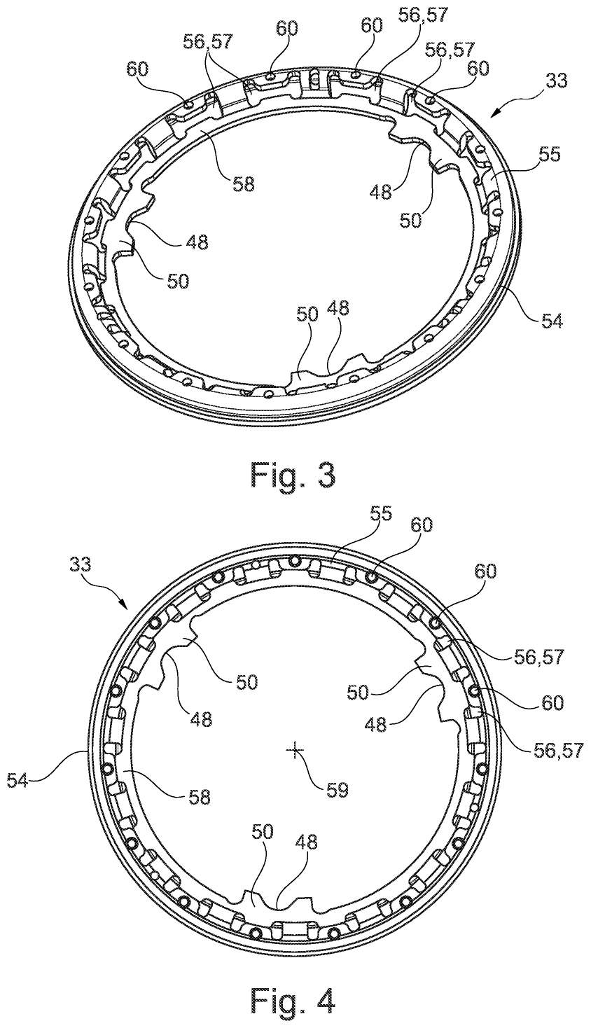

The mass ring 33, as again shown in detail in FIGS. 3 to 5, has a radially outer, completely circumferential ring region 54. This ring region 54 typically forms a mass body in order to give the primary component 2 a corresponding centrifugal mass. In further embodiments, the mass ring 33 is alternatively constructed from a plurality of sub-segments adjoining one another in the circumferential direction.

On its radial inner side, the mass ring 33 forms a stop ring region 58 that is also completely circumferential and continuous. On this stop ring region 58, a plurality of tabs 50 (here three) arranged in a distributed manner in the circumferential direction protrude radially inwards. In the first exemplary embodiment, these tabs 50 are provided with indentations 48, which in principle can be regarded as optional. The tabs 50 are arranged in a uniformly distributed manner in the circumferential direction. Each tab 50 forms at least one stop 51 towards one circumferential side. In this exemplary embodiment, the circumferential sides of each tab 50 that face away from one another even form a stop 51, so each tab 50 has a total of two stops 51.

A transition region 55 is implemented radially between the (radially inner) stop ring region 58 and the (radially outer) ring region 54 arranged radially outside of said stop ring region 58 and extends in a substantially U-shaped/arcuate manner. This transition region 55 is thus flared axially relative to the ring region 54 or the stop ring region 58.

Furthermore, it can be seen that the transition region 55 is specifically designed to be weaker than the ring region 54 with respect to its rigidity, namely its torsional rigidity (in the circumferential direction). For this purpose, weak points 56 are introduced in the transition region 55 in a plurality of circumferential regions arranged in a distributed manner in the circumferential direction. Each weak point 56 is specifically implemented as a recess 57, in particular provided with this recess 57. It can also be seen that the recess 57 is arranged on a radial inner side, i.e. a side radially facing the stops 51, of the transition region 55 extending in a U-shape. The respective recess 57 forms a through-hole penetrating the transition region 55. As a result, the stop 51 is coupled relative to the ring region 54 via a specific elasticity in a targeted manner.

FIG. 6 again shows particularly well that the mass ring 33 is connected to the other components of the primary component 2 on the radial side of the transition region 55, directly adjoining the ring region 54, by the rivet bolts 46, so as to form a rivet connection. To receive the rivet bolts 46, there are a plurality of rivet holes 60 arranged in a distributed manner in the circumferential direction.

The mass ring 33 may be made integrally. For this purpose, the mass ring 33 may be made of a metal sheet/steel sheet.

The interaction of the stops 51 with the counter stops 53 should also be noted again with FIGS. 1, 7 and 8. Each flange plate 31 forms a counter stop 53 on its two circumferential sides facing away in the circumferential direction, so that each flange plate 31 has a total of two counter stops 53.

The flange plates 31 extend in such a way that their portions forming the counter stops 53 are at the same level both in the radial direction and in the axial direction as the stops 51 formed by the tabs 50 and can therefore be brought into contact in the circumferential direction/rotational direction. Therefore, the tab 50 forms a targeted stop 51 to which a counter stop 53 of the flange plate 31 can be brought into contact. Stop 51 and counter stop 53 are positioned in such a way that they come into contact with one another when the primary component 2 is rotated relative to the secondary component 3 before the compression springs 52 move to block/are completely elastically compressed.

In an alternative embodiment, two intermediate stops are provided on the rocker element 9, of which a first intermediate stop of the rocker element 9 interacts with the stop 51/can be brought directly into contact with it, and a second intermediate stop of the rocker element 9 interacts with the counter stop 53/can be brought directly into contact with it. The second intermediate stop of the rocker element 9 is then located radially inside the first intermediate stop.

In addition, the stop 51 can theoretically also be attached to the sheet metal hub/the hub element 16 instead of to the continuously circumferential stop ring region 58.

With respect to the flange plates 31, FIG. 7 also shows that each flange plate 31 forms an axial/axially flared depression 30 (in relation to the portion forming the counter stops 53) and is riveted to the output flange 11 in the region of this depression 30. In further embodiments, the depression 30 may only be formed locally around the rivet openings, instead of in the middle of the flange plate 31, as implemented here, in order to bring about a further increase in impact tolerance. The flange plates 31 may be made from a steel material DD12.

The flange plate 31 may form a window 49, as can again be seen incrementally in FIG. 1.

It can also be seen in connection with FIG. 8 that the hub element 16 may have a plurality of (axial) through-holes 18 arranged in a distributed manner in the circumferential direction, which are dimensioned in such a way that they are dimensioned to be larger than a screw head of the screw attaching the input flange 10 to the crankshaft 23.

Coming back to FIG. 18, it should also be noted that the hybrid powertrain 20 may be used in such a way that the crankshaft 23 and consequently also the carrier 27 with the clutches 28a, 28b and the separating clutch 25 are arranged coaxially and transverse, namely perpendicular, to a vehicle longitudinal axis 29 of the motor vehicle 21. In further embodiments, however, these components are also oriented longitudinally/parallel to the vehicle longitudinal axis 29.

FIGS. 13 to 16 illustrate the second exemplary embodiment. Here, the flange plates 31 can also be formed without a window 49. Furthermore, the mass ring 33 is designed with a constant inner diameter on the side of its tabs 50 projecting radially inwards, instead of with a radial recess/indentation 48 as in the first exemplary embodiment. Four rivet elements 35 are also provided for each rocker element 9.

In other words, according to the present disclosure, a damping unit (pendular rocker damper 1) is implemented with a separate impact protection in order to protect the compression springs 52, such as in a pendular rocker damper or a clutch disk, from this high torque. This is implemented with a mass ring 33 with stops 51 and stop flanges (flange plates 31) as counterparts. In order to achieve the necessary mass moment of inertia in a pendular rocker damper 1, which is also to be used as a damping unit between the internal combustion engine 22 and the transmission 38, the mass ring 33 is used, which is provided with an additional function in that stops 51 are provided on this mass ring 33 in a targeted manner. The mass ring 33 is thus part of the primary mass (primary component 2) and provides the stop flanges with a stop 51 in the event of an impact before the compression springs 52 move to block.

The stop flanges are mounted on the secondary mass (secondary component 3) and thus have a relative movement in the circumferential direction to the primary mass. Depending on the torque to be transmitted, there is a specific torsion angle between the secondary mass and the primary mass. During normal operation, the stops 51 do not come into contact, so the torque is not transmitted via the stop flanges. However, if there is an impact that is far above the actual engine torque, the torsion angle is so large that the stop flanges move against the mass ring 33 with the stops 51, so the torque is transmitted via the stop flanges and the compression springs 52 are no longer loaded. The larger the diameter and thus also the lever arm of the torque, the smaller the circumferential force which the mass ring 33, which lies on the largest possible diameter, has to withstand.

In order to realize a softer connection, the mass ring 33 is also designed to be stress-optimized. The mass ring 33 itself is closed and has rivet holes 60 in order to be able to be connected to the rest of the primary mass. The rivet holes 60 and the closed ring (ring region 54) thus form a unit that is rigid so that no major deformations occur at these points. The stops 51 themselves are exposed on the mass ring 33 and are not continuously connected to the closed mass ring 33. This means that there are recesses 57 between the stops 51 and the closed ring. As a result, the stops 51 are connected more softly in comparison with the closed ring and the region of the rivets. A higher deformation can therefore occur here so that an impact torque can be withstood.

### REFERENCE NUMERALS

1 Pendular rocker damper
2 Primary component
3 Secondary component
4 Ring element
5 Inner side
6 First roller body
7 First guide track
8 Second guide track
9 Rocker element
10 Input flange
11 Output flange
12 Second roller body
13 Third guide track
14 Fourth guide track
15 Spring unit
16 Hub element
17 Recess
18 Through-hole
19 Transmission ring
20 Hybrid powertrain
21 Motor vehicle
22 Internal combustion engine
23 Crankshaft
24 Electric drive machine
25 Separating clutch
26 Rotor
27 Carrier
28a First clutch
28b Second clutch
29 Vehicle longitudinal axis
30 Depression
31 Flange plate
32 Drive device
33 Mass ring
34a First rocker plate
34b Second rocker plate
35 Rivet element
36 Support disk
37 Wheel
38 Transmission
39a First transmission input shaft
39b Second transmission input shaft
40 Rotor shaft
41 Gear stage
42a First clutch component
42b Second clutch component
43 Intermediate shaft
44 Differential stage
45 Toothing
46 Rivet bolt
47 Rivet projection
48 Indentation
49 Window
50 Tab
51 Stop
52 Compression spring
53 Counter stop
54 Ring region
55 Transition region
56 Weak point
57 Recess
58 Stop ring region
59 Axis of rotation
60 Rivet hole

1. A pendular rocker damper for a hybrid powertrain of a motor vehicle, comprising a primary component, a secondary component which can be rotated relative to the primary component to a limited degree, and at least one rocker element which is suspended on the primary component and the secondary component in a pendular manner and which is used for torque transmission, wherein the at least one rocker element is coupled to the primary component by means of a first roller body that is received in guide tracks so as to roll or is coupled to the secondary component by means of a second roller body likewise received in guide tracks so as to roll, wherein the at least one rocker element is resiliently supported by at least one compression spring, and wherein a stop attached to the primary component interacts with a counter stop attached to the secondary component such that the primary component and the secondary component are supported in relation to one another in a circumferential direction after the at least one compression spring is displaced by a specified elastic spring deflection.

2. The pendular rocker damper according to claim 1, wherein the stop is formed by a tab projecting radially inwards.

3. The pendular rocker damper according to claim 1, wherein the counter stop is formed on a flange plate of the secondary component.

4. The pendular rocker damper according to claim 3, wherein the flange plate is arranged in such a way that the counter stop is positioned adjacent to the stop in the circumferential direction at the same level in the radial direction and in the axial direction as the stop.

5. The pendular rocker damper according to one of claim 1, wherein the stop is formed on a mass ring which at least partially also forms the primary component.

6. The pendular rocker damper according to claim 5, wherein the mass ring has a completely circumferential ring region and the tab forming the stop is integrally formed with said ring region.

7. The pendular rocker damper according to claim 6, wherein a weak point which reduces the rigidity in a targeted manner in relation to the ring region is introduced in a transition region between the stop and the ring region.

8. The pendular rocker damper according to claim 1, wherein the stop is arranged on a continuously circumferential stop ring region and said stop ring region is coupled by means of a perforated transition region to a ring region further connected to at least one ring element of the primary component.

9. The pendular rocker damper according to claim 1, wherein a plurality of stops and a plurality of counter stops, each associated with a stop, are arranged in a distributed manner in the circumferential direction.

10. A hybrid powertrain for a motor vehicle, having an internal combustion engine, a pendular rocker damper according to claim 1, wherein the primary component of the pendular rocker damper is attached to a crankshaft of the internal combustion engine, having an electric drive machine and having a separating clutch operatively inserted between the internal combustion engine and the electric drive motor.

11. A pendular rocker damper for a hybrid powertrain of a motor vehicle comprising:
a primary component;
a stop attached to the primary component;
a secondary component rotatable relative to the primary component to a limited degree;
a counter stop attached to the secondary component;
a rocker element used for torque transmission, the rocker element suspended on the primary component and the secondary component in a pendular manner;
a first roller body coupling the rocker element to the primary component, the first roller body arranged to roll in a first guide track;
a second roller body coupling the rocker element to the secondary component, the second roller body arranged to roll in a second guide track; and
a compression spring resiliently supporting the rocker element, wherein the stop interacts with the counter stop to support the primary component relative to the secondary component in a circumferential direction once the compression spring is displaced by a specified elastic spring deflection.

12. The pendular rocker damper of claim 11, wherein the stop is formed by a tab projecting radially inwards.

13. The pendular rocker damper of claim 11, wherein:
the secondary component comprises a flange plate; and
the counter stop is formed on the flange plate.

14. The pendular rocker damper of claim 13, wherein the flange plate is arranged such that:
the counter stop is positioned adjacent to the stop in the circumferential direction; and
the counter stop is positioned aligned with the stop in a radial direction and an axial direction.

15. The pendular rocker damper of claim 11, wherein:
the primary component is partially formed by a mass ring; and
the stop is formed on the mass ring.

16. The pendular rocker damper of claim 15, wherein:
the mass ring comprises a completely circumferential ring region; and
the stop is formed by a tab integrally formed with the circumferential ring region.

17. The pendular rocker damper of claim 16, wherein the mass ring comprises a transition region having a weak point with reduced rigidity arranged between the stop and the circumferential ring region.

18. The pendular rocker damper of claim 11, wherein:
the primary component comprises a ring element;
the stop is arranged on a continuously circumferential stop ring region;
the circumferential stop ring region is coupled to a ring region by a perforated transition region; and
the ring region is coupled to the ring element.

19. The pendular rocker damper of claim 11 further comprising:
a plurality of stops distributed about the circumferential direction; and
a plurality of counter stops, each associated with a stop.
